(19) United States
(12) Patent Application Publication
(10) Pub. No.: US 2025/0043054 A1
(43) Pub. Date: Feb. 6, 2025

(54) METHOD FOR MANUFACTURING LARGE-PARTICLE-SIZE STYRENE BUTADIENE LATEX

(71) Applicant: NANTEX INDUSTRY CO., LTD., Kaohsiung City (TW)

(72) Inventors: Chun-Wei LIAO, Kaohsiung City (TW); Pen-Hsin CHOU, Kaohsiung City (TW)

(21) Appl. No.: 18/520,778

(22) Filed: Nov. 28, 2023

(30) Foreign Application Priority Data
Aug. 3, 2023 (TW) 112129189

(51) Int. Cl. C08F 236/10; C08F 2/22; C08F 236/06

(52) U.S. Cl. CPC C08F 236/10; C08F 2/22; C08F 236/06

(57) ABSTRACT

A method for manufacturing a large-particle-size styrene butadiene latex includes mixing a first styrene-butadiene latex with a polyacrylate agglomerating agent and an inorganic salt solution to allow the first styrene-butadiene latex to undergo an agglomeration process, so as to obtain a second styrene-butadiene latex that has a particle size larger than that of the first styrene-butadiene latex. The polyacrylate agglomerating agent is present in an amount ranging from 0.1 parts by weight to 1 part by weight and an inorganic salt in the inorganic salt solution is present in an amount of 0.25 parts by weight, based on 100 parts by weight of the first styrene-butadiene latex. The first styrene-butadiene latex is stable and not susceptible to emulsion breaking during the agglomeration process.

### CROSS-REFERENCE TO RELATED APPLICATION

This application claims priority to Taiwanese Invention Patent Application No. 112129189, filed on Aug. 3, 2023, and incorporated by reference herein in its entirety.

### FIELD

The present disclosure relates to a method for manufacturing a latex, and more particularly to a method for manufacturing a large-particle-size styrene-butadiene latex.

### BACKGROUND

With the current state of technology, the direct production of styrene-butadiene latex in large particle sizes is still difficult. Therefore, in order to increase the particle size of the styrene-butadiene latex, a small-particle-size styrene-butadiene latex is usually synthesized in advance, followed by partial destabilization using physical or chemical methods, so that the small-particle-size styrene-butadiene latex undergoes an agglomeration process and becomes a stable large-particle-size styrene-butadiene latex.

A conventional agglomeration method for increasing a particle size of a latex includes a physical agglomeration method (such as freeze agglomeration method and pressure agglomeration method) and a chemical agglomeration method (such as acid agglomeration method, alkaline agglomeration method, and salt agglomeration method). However, the physical agglomeration method has high requirements on equipment, such as low-temperature resistance and high-pressure resistance, and an agglomeration process of the chemical agglomeration method is difficult to control, resulting in poor repeatability. In addition, both the physical agglomeration method and chemical agglomeration method have limited ability to increase the particle size of the latex. Hence, the industry currently utilizes another agglomeration method known as a polymer agglomeration method which is characterized by straightforward agglomeration procedures, gentle agglomeration conditions, a concentrated distribution of latex particle size, and the ease of controlling the degree of latex particle size increase.

The polymer agglomeration method involves introducing a polymer agglomerating agent, derived from a polymerization reaction, into a small-particle-size latex (i.e., a first latex), so as to obtain a second latex with larger particle sizes compared to the first latex. Furthermore, by virtue of adjusting the amount of the polymer agglomerating agent, the purpose of controlling the particle size of the second latex can be achieved, and thus the polymer agglomeration method has great potential for development and practical value. For example, the polymer agglomeration method has wide significant prospects in the productions of acrylonitrile-butadiene-styrene (ABS) resin, acrylic resin (ACR), methacrylate-butadiene-styrene (MBS) resin, and rubber reinforcing resin. In particular, due to the large-particle-size latex (i.e., the second latex) having excellent energy absorption capability, the resultant ABS resin exhibits outstanding impact resistance.

In spite of the aforesaid, there is still a need to develop an effective way for manufacturing a large-particle-size styrene-butadiene latex using a polymer agglomerating agent.

### SUMMARY

Therefore, an object of the present disclosure is to provide a method for manufacturing a large-particle-size styrene-butadiene latex, which can alleviate at least one of the drawbacks of the prior art.

According to the disclosure, the method includes mixing a first styrene-butadiene latex with a polyacrylate agglomerating agent and an inorganic salt solution to allow the first styrene-butadiene latex to undergo an agglomeration process, so as to obtain a second styrene-butadiene latex. The second styrene-butadiene latex has a particle size larger than that of the first styrene-butadiene latex. The polyacrylate agglomerating agent is present in an amount ranging from 0.1 parts by weight to 1 part by weight and an inorganic salt in the inorganic salt solution is present in an amount of 0.25 parts by weight, based on 100 parts by weight of the first styrene-butadiene latex. The first styrene-butadiene latex is stable and not susceptible to emulsion breaking during the agglomeration process.

### DETAILED DESCRIPTION

For the purpose of this specification, it will be clearly understood that the word “comprising” means “including but not limited to”, and that the word “comprises” has a corresponding meaning.

It is to be understood that, if any prior art publication is referred to herein, such reference does not constitute an admission that the publication forms a part of the common general knowledge in the art, in Taiwan or any other country.

Unless defined otherwise, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides a method for manufacturing a large-particle-size styrene-butadiene latex, which includes mixing a first styrene-butadiene latex with a polyacrylate agglomerating agent and an inorganic salt solution to allow the first styrene-butadiene latex to undergo an agglomeration process, so as to obtain a second styrene-butadiene latex. The second styrene-butadiene latex has a particle size larger than that of the first styrene-butadiene latex.

According to the present disclosure, the polyacrylate agglomerating agent is present in an amount ranging from 0.1 parts by weight to 1 part by weight and an inorganic salt in the inorganic salt solution is present in an amount of 0.25 parts by weight, based on 100 parts by weight of the first styrene-butadiene latex. The first styrene-butadiene latex is stable and not susceptible to emulsion breaking during the agglomeration process.

According to the present disclosure, the first styrene-butadiene latex is obtained by subjecting a component containing a 1,3-butadiene and a styrene monomer to a polymerization reaction, so that the 1,3-butadiene and the styrene monomer can be converted into the styrene-butadiene latex. In particular, the total percentage of the 1,3-butadiene and the styrene monomer converted to the styrene-butadiene latex is known as “conversion rate of the first styrene-butadiene latex”. In the component, the amount of the 1,3-butadiene and the amount of the styrene monomer are not particularly limited and can be flexibly adjusted according to actual demands. In certain embodiments, the conversion rate of the first styrene-butadiene latex is not lower than 95%. In certain embodiments, the first styrene-butadiene latex has a mean particle size ranging from 70 nm to 100 nm.

According to the present disclosure, by virtue of the combined use of the polyacrylate agglomerating agent and the inorganic salt solution, the mean particle size of the first styrene-butadiene latex can be effectively increased. In certain embodiments, the polyacrylate agglomerating agent is obtained by the steps of:
(a) subjecting a first component including an acrylate monomer, a surfactant, and a sodium naphthalene sulfonate to an emulsion reaction so as to form an emulsion;
(b) subjecting the emulsion to a polymerization reaction with an ammonium persulfate at a temperature of 55° C. so as to form a mixture; and
(c) dripping a second component including an acrylate monomer, (meth)acrylic acid, and a surfactant into the mixture to undergo a polymerization reaction.

According to the present disclosure, the surfactant in each of the first component and the second component may be selected from the group consisting of an anionic surfactant, a nonionic surfactant, and a combination thereof.

According to the present disclosure, the purpose of dripping the second component into the mixture to undergo the polymerization reaction is to decrease the heat generated during the polymerization reaction, thereby avoiding difficulty in controlling temperature due to a rapid reaction rate. The polymerization reaction converts the acrylate monomers in the first component and the second component and the (meth)acrylic acid in the second component into the polyacrylate agglomerating agent in the form of an emulsion. In particular, the total percentage of the acrylate monomers and the (meth)acrylic acid converted to the polyacrylate agglomerating agent is known as “conversion rate of the polyacrylate agglomerating agent”. In certain embodiments, the conversion rate of the polyacrylate agglomerating agent is not lower than 96%. In certain embodiments, the polyacrylate agglomerating agent has a mean particle size ranging from 90 nm to 150 nm. In certain embodiments, the polyacrylate agglomerating agent has a pH value ranging from 2 to 4.

According to the present disclosure, the acrylate monomer in each of the first component and the second component may be selected from the group consisting of ethyl acrylate, n-butyl acrylate, and a combination thereof. In certain embodiments, the acrylate monomer in each of the first component and the second component is ethyl acrylate. In certain embodiments, the acrylate monomers in the first component and the second component are present in a total amount ranging from 80 wt % to 95 wt %, based on the total weight of the acrylate monomers in the first component and the second component and the (meth)acrylic acid in the second component. In certain embodiments, a weight ratio of the acrylate monomer in the second component to the acrylate monomer in the first component in decimal form ranges from 1.5 to 2.

According to the present disclosure, the anionic surfactant may include, but is not limited to, sodium dodecyl sulfate, and the nonionic surfactant may include, but is not limited to, polyoxyethylene nonylphenol phosphate. In certain embodiments, the anionic surfactant is sodium dodecyl sulfate, and the nonionic surfactant is polyoxyethylene nonylphenol phosphate.

As used herein, the term “(meth)acrylic acid” refers to acrylic acid or methacrylic acid. In certain embodiments, in order to further substantially increase the mean particle size of the first styrene-butadiene latex, the (meth)acrylic acid is present in an amount ranging from 5 wt % to 20 wt %, based on the total weight of the acrylate monomers in the first component and the second component and the (meth)acrylic acid in the second component.

According to the present disclosure, the inorganic salt solution may be selected from the group consisting of a potassium chloride (KCl) solution and a sodium chloride (NaCl) solution. In certain embodiments, the inorganic salt solution is the potassium chloride (KCl) solution. In certain embodiments, the inorganic salt in the inorganic salt solution is present in an amount of 0.25 parts by weight, based on 100 parts by weight of the first styrene-butadiene latex. In certain embodiments, the inorganic salt solution contains 10 wt % of the inorganic salt.

In certain embodiments, the second styrene-butadiene latex has a mean particle size ranging from 110 nm to 800 nm.

The disclosure will be further described by way of the following examples. However, it should be understood that the following examples are solely intended for the purpose of illustration and should not be construed as limiting the disclosure in practice.

### EXAMPLES

### Preparative Example 1 (PE1): First Styrene-Butadiene Latex

248 g of 1,3-butadiene, 101.3 g of styrene monomer, 11.4 g of potassium stearate, and 368.6 g of water were mixed together, so as to obtain a mixture. Then, 0.6 g of sodium naphthalene sulfonate, 1.9 g of potassium chloride (KCl), and 1.75 g of tert-dodecylthiol were added into the mixture, and then stirred for 30 minutes, followed by adding 2.25 g of potassium persulfate so as to allow a polymerization reaction to occur at a temperature of 70° C. for 9 hours, so that the 1,3-butadiene and the styrene monomer were converted into a styrene-butadiene latex (hereinafter referred to as “first styrene-butadiene latex”). The thus obtained first styrene-butadiene latex was subjected to determination of conversion rate using technology well known to those skilled in the art and mean particle size using a laser scattering particle size analyzer (Manufacturer: Otsuka; Model no.: nanoSAQLA). The results showed that the conversion rate of the first styrene-butadiene latex was 95% and the first styrene-butadiene latex had a mean particle size of 80 nm.

### Preparative Example 2 (PE2): Polyacrylate Agglomerating Agent

81.64 g of ethyl acrylate, 2.58 g of sodium dodecyl sulfate, 0.11 g of tert-dodecylthiol, and 0.6 g of sodium naphthalene sulfonate were mixed with 335 g of water, so as to obtain a first component. Then, the first component was stirred for 30 minutes to allow an emulsion reaction so as to form an emulsion. The emulsion was subsequently subjected to a polymerization reaction with an ammonium persulfate at a temperature of 55° C. so as to form a mixture, followed by continuously dripping, into the mixture, a second component including 122.46 g of ethyl acrylate, 10.74 g of methacrylic acid, 3.87 g of sodium dodecyl sulfate and 142 g of water, to allow a polymerization reaction to occur at a temperature of 55° C. for 6.5 hours, so that the ethyl acrylates in the first component and the second component and the methacrylic acid in the second component were converted into a polyacrylate agglomerating agent in the form of an emulsion. The thus obtained polyacrylate agglomerating agent was subjected to determination of conversion rate using technology well known to those skilled in the art, mean particle size using the laser scattering particle size analyzer, and pH value using a pH meter (Manufacturer: Metrohm; Model no.: 913). The results showed that the conversion rate of the polyacrylate agglomerating agent was 96%, and the polyacrylate agglomerating agent had a mean particle size of 91 nm and a pH value ranging from 2 to 4.

The materials and the amounts thereof for making the first component and the second component are shown in Table 1 below. As shown in Table 1, the ethyl acrylate in the first component was present in an amount of 38 wt %, the ethyl acrylate in the second component was present in an amount of 57 wt %, and the methacrylic acid in the second component was present in an amount of 5 wt %, based on the total weight of the ethyl acrylates in the first component and the second component and the methacrylic acid in the second component.

### Preparative Examples 3 to 5 (PE3 to PE5): Polyacrylate Agglomerating Agent

The procedures for preparing the polyacrylate agglomerating agents of PE3 to PE5 were similar to those of PE2, except that the materials and the amounts thereof for making the first component and the second component, and the reaction times for the polymerization reaction were varied as shown in Table 1 below. To be specific, for PE3, the amount of the ethyl acrylate in the first component was adjusted to 32 wt % and the amount of the ethyl acrylate in the second component was adjusted to 63 wt %; for PE4, the amount of the ethyl acrylate in the first component was adjusted to 32 wt %, the amount of the ethyl acrylate in the second component was adjusted to 48 wt %, and the amount of the methacrylic acid in the second component was adjusted to 20 wt %; for PE5, the amount of the ethyl acrylate in the first component was adjusted to 32 wt %, the amount of the ethyl acrylate in the second component was adjusted to 48 wt %, and the amount of the methacrylic acid in the second component was adjusted to 20 wt %, and the sodium dodecyl sulfate was replaced with polyoxyethylene nonylphenol phosphate with CAS number 51811-79-1.

TABLE 1

| Polyacrylate agglomerating agent | | | PE2 | PE3 | PE4 | PE5 |
|---|---|---|---|---|---|---|
| First | Ethyl | (g) | 81.64 | 68.75 | 68.75 | 68.75 |
| component | acrylate | (wt %) | 38 | 32 | 32 | 32 |
| | Sodium dodecyl sulfate (g) | | 2.58 | 2.58 | 2.58 | 0 |
| | Polyoxyethylene | | 0 | 0 | 0 | 2.58 |
| | nonylphenol phosphate (g) | | | | | |
| | Tert-dodecylthiol (g) | | 0.11 | 0.11 | 0.11 | 0.11 |
| | Sodium naphthalene | | 0.6 | 0.6 | 0.6 | 0.6 |
| | sulfonate (g) | | | | | |
| | Water (g) | | 335 | 323 | 323 | 323 |
| Mixture | Ammonium persulfate (g) | | 0.6 | 0.6 | 0.6 | 0.6 |
| Second | Ethyl | (g) | 122.46 | 135.35 | 103.12 | 103.12 |
| component | acrylate | (wt %) | 57 | 63 | 48 | 48 |
| | Methacrylic | (g) | 10.74 | 10.74 | 42.97 | 42.97 |
| | acid | (wt %) | 5 | 5 | 20 | 20 |

| | | | | | |
|---|---|---|---|---|---|
| | Sodium dodecyl sulfate (g) | 3.87 | 3.87 | 3.87 | 0 |
| | Polyoxyethylene | 0 | 0 | 0 | 3.87 |
| | nonylphenol phosphate (g) | | | | |
| | Water (g) | 142 | 154 | 154 | 154 |
| Polymerization | Temperature (° C.) | 55 | 55 | 55 | 55 |
| reaction | Time (hours) | 6.5 | 6.5 | 5 | 3.5 |

| | | | | |
|---|---|---|---|---|
| Particle size of polyacrylate agglomerating | 91 | 111 | 106 | 143 |
| agent (nm) | | | | |
| Conversion rate of polyacrylate | 96 | 96 | 96 | 97 |
| agglomerating agent (%) | | | | |

### Example 1 (EX1): Second Styrene-Butadiene Latex

The first styrene-butadiene latex of PE1 was stirred at a temperature of 50° C. and was added with a potassium chloride solution containing 10 wt % of the potassium chloride and the polyacrylate agglomerating agent of PE2, followed by stirring for 1 hour to allow the first styrene-butadiene latex of PE1 to undergo an agglomeration process, thereby increasing the particle size of the first styrene-butadiene latex of PE1, so that the first styrene-butadiene latex is formed into a second styrene-butadiene latex. Thereafter, the resultant mixture containing the second styrene-butadiene latex was subjected to property evaluation as described below.

The materials and the amounts thereof for making the second styrene-butadiene latex of EX1 are shown in Table 2 below. As shown in Table 2, the potassium chloride was present in an amount of 0.25 parts by weight and the polyacrylate agglomerating agent of PE2 was present in an amount of 0.1 parts by weight, based on 100 parts by weight of the first styrene-butadiene latex of PE1.

### Examples 2 to 5 (EX2 to EX5): Second Styrene-Butadiene Latex

The procedures for preparing the second styrene-butadiene latexes of EX2 to EX5 were similar to those of EX1, except that the amounts and types of the polyacrylate agglomerating agent were varied as shown in Table 2 below.

### Comparative Example 1 (CE1): Second Styrene-Butadiene Latex

The first styrene-butadiene latex of PE1 was stirred at a temperature of 50° C. and was added with a potassium chloride solution containing 10 wt % of the potassium chloride, followed by stirring for 1 hour to allow the first styrene-butadiene latex of PE1 to undergo an inorganic salt induced-agglomeration process, thereby increasing the particle size of the first styrene-butadiene latex of PE1, so that the first styrene-butadiene latex is formed into a second styrene-butadiene latex. Thereafter, the resultant mixture containing the second styrene-butadiene latex was subjected to property evaluation as described below.

The materials and the amounts thereof for making the second styrene-butadiene latex of CE1 are shown in Table 2 below. As shown in Table 2, the potassium chloride was present in an amount of 0.25 parts by weight, based on 100 parts by weight of the first styrene-butadiene latex of PE1.

### Property Evaluation

### A. Measurement of Mean Particle Size of Second Styrene-Butadiene Latex

The mixture containing the second styrene-butadiene latex for each of EX1 to EX5 and CE1 was subjected to determination of mean particle size of the second styrene-butadiene latex using the laser scattering particle size analyzer (Manufacturer: Otsuka; Model no.: nanoSAQLA).

### B. Measurement of Rubber Yield

A respective one of the mixtures containing the second styrene-butadiene latex of EX1 to EX5 and CE1 was filtered through an iron sieve (pore size: 100 mesh), and a rubber residue remaining on the iron sieve, which was formed by an emulsion breaking of the first styrene-butadiene latex during the agglomeration process, was subjected to a drying treatment at a temperature of 105° C. for 1 hour, thereby obtaining a dry rubber. In addition, the mixture containing the second styrene-butadiene latex for each of EX1 to EX5 and CE1 was subjected to a drying treatment at a temperature of 105° C. for 1 hour, so as to obtain a dry mixture. Then, the dry rubber and the dry mixture were respectively weighed to determine weights thereof.

The rubber yield was calculated using the following Equation (1):

$$A = [ C / B ] \times 100 \% \qquad ( 1 )$$

where A=rubber yield (%)
B=weight of dry mixture determined in the respective one of EX1 to EX5 and CE1
C=weight of dry rubber determined in the respective one of EX1 to EX5 and CE1

The lower the rubber yield was, the less the amount of rubber formed by the emulsion breaking of the first styrene-butadiene latex during the agglomeration process was. That is, if the first styrene-butadiene latex was more stable during the agglomeration process, the particle size of the first styrene-butadiene latex was effectively increased, so that a second styrene-butadiene latex having a mean particle size larger than that of the first styrene-butadiene latex can be obtained.

### Results

TABLE 2

| | | EX1 | EX2 | EX3 | EX4 | EX5 | CE1 |
|---|---|---|---|---|---|---|---|
| First styrene- | Preparative Example | PE1 | PE1 | PE1 | PE1 | PE1 | PE1 |
| butadiene | Mean particle size | 80 | 80 | 80 | 80 | 80 | 80 |
| latex | (nm) | | | | | | |
| Inorganic salt | Amount of inorganic | 0.25 | 0.25 | 0.25 | 0.25 | 0.25 | 0.25 |
| solution | salt (parts by weight) | | | | | | |
| | Type of inorganic salt | KCl | KCl | KCl | KCl | KCl | KCl |
| | Inorganic salt | 10 | 10 | 10 | 10 | 10 | 10 |
| | concentration (%) | | | | | | |
| Polyacrylate | Preparative Example | PE2 | PE3 | PE4 | PE5 | PE4 | Not |
| agglomerating | | | | | | | added |
| agent | Amount (parts by | 0.1 | 0.1 | 0.1 | 0.1 | 1 | Not |
| | weight) | | | | | | added |
| Second | Rubber yield (%) | 0.07 | 0.03 | 0.01 | 0.12 | 0.03 | 0.01 |
| styrene- | Mean particle size | 110 | 118 | 248 | 185 | 775 | 84 |
| butadiene | (nm) | | | | | | |
| latex | | | | | | | |

Referring to Table 2, in EX1 to EX5, by virtue of using the polyacrylate agglomerating agent of the respective one of PE2 to PE5 in combination with the inorganic salt and controlling the amount of the polyacrylate agglomerating agent and the inorganic salt, the respective first styrene-butadiene latex can undergo an agglomeration process, and hence the mean particle size (i.e., 80 nm) of the first styrene-butadiene latex can be effectively and significantly increased, thereby obtaining the second styrene-butadiene latex having a mean particle size ranging from 110 nm to 775 nm. Notably, in EX1 to EX4, by virtue of increasing the amount of methacrylic acid in the second component from 5 wt % to 20 wt %, and adjusting the type of surfactant, the method of the present disclosure enables the first styrene-butadiene latex to achieve an excellent agglomeration effect. Furthermore, as shown in EX3 and EX5, by further increasing the amount of the polyacrylate agglomerating agent from 0.1 parts by weight to 1 part by weight, the mean particle size of the second styrene-butadiene latex can be increased.

In contrast, in CE1, only the inorganic salt was used in the same amount as in EX1 to EX5 to undergo the inorganic salt induced-agglomeration process without an addition of any polyacrylate agglomerating agent, and thus the mean particle size (i.e., 80 nm) of the first styrene-butadiene latex of CE1 cannot be effectively and significantly increased, so that the thus obtained second styrene-butadiene latex only has a mean particle size of 84 nm. These results indicates that the inorganic salt induced-agglomeration process used in CE1 has a limited effect on increasing the mean particle size of the second styrene-butadiene latex.

In summary, it is clear that in the method for manufacturing a large-particle-size styrene-butadiene latex of the present disclosure, by virtue of using the respective one of the polyacrylate agglomerating agents of PE2 to PE5 with the inorganic salt and controlling the amount of the polyacrylate agglomerating agent and the inorganic salt, only a small amount of the polyacrylate agglomerating agent is required to allow the respective first styrene-butadiene latex to undergo an agglomeration process, and the first styrene-butadiene latex is stable and not susceptible to emulsion breaking during the agglomeration process, and thus the mean particle size of the first styrene-butadiene latex can be effectively increased so that the first styrene-butadiene latex forms a second styrene-butadiene latex having a mean particle size larger than that of the first styrene-butadiene latex. Notably, the method for manufacturing a large-particle-size styrene-butadiene latex of the present disclosure is capable of replacing a conventional method that relies on increasing the amount of inorganic salt to achieve a corresponding increase in the agglomeration effect. The method of the present disclosure only requires a small amount of the polyacrylate agglomerating agent to exhibit an excellent agglomeration effect, and hence can effectively manufacture a large-particle-size styrene-butadiene latex.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for manufacturing a large-particle-size styrene-butadiene latex, comprising:
mixing a first styrene-butadiene latex with a polyacrylate agglomerating agent and an inorganic salt solution to allow the first styrene-butadiene latex to undergo an agglomeration process, so as to obtain a second styrene-butadiene latex, the second styrene-butadiene latex having a particle size larger than that of the first styrene-butadiene latex;
wherein the polyacrylate agglomerating agent is present in an amount ranging from 0.1 parts by weight to 1 part by weight and an inorganic salt in the inorganic salt solution is present in an amount of 0.25 parts by weight, based on 100 parts by weight of the first styrene-butadiene latex, and the first styrene-butadiene latex is stable and not susceptible to emulsion breaking during the agglomeration process.

2. The method as claimed in claim 1, wherein the polyacrylate agglomerating agent is obtained by the steps of:
(a) subjecting a first component including an acrylate monomer, a surfactant, and a sodium naphthalene sulfonate to an emulsion reaction so as to form an emulsion;
(b) subjecting the emulsion to a polymerization reaction with an ammonium persulfate so as to form a mixture; and
(c) dripping a second component including an acrylate monomer, (meth)acrylic acid, and a surfactant into the mixture to undergo a polymerization reaction;
wherein the surfactant in each of the first component and the second component is selected from the group consisting of an anionic surfactant, a nonionic surfactant, and a combination thereof.

3. The method as claimed in claim 2, wherein the (meth)acrylic acid is present in an amount ranging from 5 wt % to 20 wt %, based on the total weight of the acrylate monomers in the first component and the second component and the (meth)acrylic acid in the second component.

4. The method as claimed in claim 2, wherein the acrylate monomer in each of the first component and the second component is selected from the group consisting of ethyl acrylate, n-butyl acrylate, and a combination thereof.

5. The method as claimed in claim 2, wherein the anionic surfactant is sodium dodecyl sulfate, and the nonionic surfactant is polyoxyethylene nonylphenol phosphate.

6. The method as claimed in claim 2, wherein the polyacrylate agglomerating agent has a pH value ranging from 2 to 4.

7. The method as claimed in claim 1, wherein the inorganic salt solution is selected from the group consisting of a potassium chloride solution and a sodium chloride solution.

8. The method as claimed in claim 1, wherein the inorganic salt solution contains 10 wt % of the inorganic salt.

9. The method as claimed in claim 1, wherein the second styrene-butadiene latex has a mean particle size ranging from 110 nm to 800 nm.

10. The method as claimed in claim 1, wherein the first styrene-butadiene latex has a mean particle size ranging from 70 nm to 140 nm.
